(19) United States
(12) Patent Application Publication
(10) Pub. No.: US 2025/0117768 A1
(43) Pub. Date: Apr. 10, 2025

(54) Paperless Receipt

(71) Applicant: Kamyar Boroosan, North Vancouver (CA)

(72) Inventor: Kamyar Boroosan, North Vancouver (CA)

(21) Appl. No.: 18/620,277

(22) Filed: Mar. 28, 2024

Related U.S. Application Data
(60) Provisional application No. 63/588,049, filed on Oct. 5, 2023.

(51) Int. Cl. G06Q 20/20; G06Q 20/04; G06Q 20/32

(52) U.S. Cl. CPC G06Q 20/209; G06Q 20/047; G06Q 20/3278

(57) ABSTRACT

A paperless receipt technology is disclosed that comprises an API that produces a QR code at the POS terminal. This can be integrated into POS systems in a wide variety of settings, such as banks, restaurants, retail shops, etc. Any merchant could gradually reduce their costs significantly, as the need of hardware and paper will be reduced. Once the user opts for a paperless receipt, a QR code is generated that the user can scan. A QR code or the user's phone's NFC chip may be used. Once scanned, the user will be taken to a secure website with their receipt. The receipt can then be saved and downloaded on the mobile device and placed into a folder. Others can access the shared folder at the user's discretion, such as the user's accountant.

### CROSS-REFERENCE TO RELATED APPLICATION

The present application claims priority to, and the benefit of, U.S. Provisional Application No. 63/588,049, which was filed on Oct. 5, 2023, and is incorporated herein by reference in its entirety.

### FIELD OF THE INVENTION

The present invention relates generally to the field of paperless point-of-sale (POS) receipt. More specifically, the present invention relates to an application programming interface (API) that produces a quick response (QR) code at a POS terminal that a user can scan to download a digital copy of their receipt. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in paperless receipts. Generally, many individuals opt for a paperless receipt option for convenience and to conserve paper. However, conventional methods for getting an electronic receipt involve the user having to share personal information, such as their email address or phone number. Inevitably this information can end up sold or shared with unverified parties. In addition, the electronic receipts end up in a variety of different locations, such as in text messages and emails that do not allow the user to easily compile them. There is some manual work involved with the current process, such as forwarding the email to an accountant or manually saving the receipt into a folder that users have shared with their accountant.

Furthermore, the drive to develop paperless transaction systems is generally supported by both merchants and customers. An electronic receipt would typically be easier and more reliable for a customer to manage than a paper receipt, and the electronic record provides a permanent record of a purchase while minimizing paper waste. Merchants also generally support the concept of electronic receipting to minimize receipt printing costs and to be seen as innovative and responsive to the needs of their customers and to be counted as a green company.

While customers may desire electronic receipts rather than a printed copy, the electronic receipting systems suggested to date have proved difficult to incorporate into existing POS systems. The chief difficulty has been security. That is, POS systems are typically sold with an on-board software system that may be specific to the merchant's business. The merchant is able to make minor programming adjustments to add discount codes and other special offers but has limited ability to add functionality to the POS system. Further, the merchant is typically quite concerned with the integrity of their electronic record-keeping system and is therefore hesitant to allow direct customer interaction with the POS system. However, a merchant might be more willing to email an electronic receipt to customers. However, customers tend to resist providing personal information, such as an email address, to a merchant in a public place (at the point of sale) and may also be unwilling to pre-register for electronic receipts from the merchant in advance, particularly if creating an account is required, involving entry of further personal information.

Accordingly, a solution in which a merchant may provide electronic receipts to customers without modification to the merchant's POS software, and without requiring customer information to be entered or stored, would be desirable. More particularly, there is a demand for a paperless receipt that enables users to download their receipts from a secure website or Link, without the need to share personal information, such as phone numbers or email addresses.

Therefore, there exists a long-felt need in the art for a paperless receipt that provides an API that produces a QR code at a POS terminal that user can scan to download a digital copy of their receipt. There is also a long-felt need in the art for a paperless receipt that enables users to download their receipts from the secure website and save them in a folder on their smart device. Further, there is a long-felt need in the art for a paperless receipt that allows the user to share the folder with others, such as their spouse or accountant. Moreover, there is a long-felt need in the art for a solution that eliminates the need for users to share personal information such as a phone number or email address to receive a paperless receipt. Further, there is a long-felt need in the art for a paperless receipt that provides a significant reduction of paper use and hardware which makes this invention environmentally friendly, as this solution motivates more people to use paperless systems. Finally, there is a long-felt need in the art for a paperless receipt that can be integrated into POS systems in a wide variety of settings.

The subject matter disclosed and claimed herein, in one embodiment thereof, comprises a paperless receipt. The technology utilizes a POS system to generate a QR code for individuals opting for a paperless receipt. The paperless receipt comprises an API that produces the QR code at the POS terminal. This can be integrated into POS systems in a wide variety of settings, such as banks, restaurants, retail shops, etc. Any merchant could gradually reduce their costs significantly, as the need of hardware and paper will be reduced. Once the user opts for a paperless receipt, a QR code is generated that the user can scan. A QR code or the user's phone's NFC chip may be used. Once scanned or Tapped the phone for NFC, the user will be taken to a secure website with their receipt. The receipt can then be saved and downloaded on the mobile device and placed into a folder. Others can access the shared folder at the user's discretion, such as the user's accountant.

In this manner, the paperless receipt of the present invention accomplishes all of the foregoing objectives and provides users with a mean that generate paperless receipts. The invention provides an API that produces a QR code at a POS terminal that a user can scan to download a digital receipt. The invention eliminates the need for users to share personal information.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a paperless receipt. The invention utilizes a technology to generate a QR code for individuals opting for a paperless receipt. The paperless receipt comprises an API that produces the QR code at the POS terminal. Once the user opts for a paperless receipt, a QR code is generated that the user can scan. Once scanned, the user will be taken to a secure website with their receipt. The receipt can then be saved and downloaded on the mobile device and placed into a folder.

In one embodiment, the paperless receipt provides a means for generating electronic receipts using data generated by a Point of Sale (POS) system. The POS system generally includes a cash register and display, a customer PIN pad with display, and a receipt printer. Generally, most POS systems are compatible with standard receipt printers. The invention disclosed utilizes the POS system to generate a QR code for individuals opting for a paperless receipt. Generally, a customer makes a purchase directly with the cashier, using the PIN pad in the customary manner to authorize payment. At some point prior to completing the transaction and having the receipt printed, the customer requests an electronic receipt. Further, in some embodiments, no customer input may be necessary and the QR code associated with the electronic receipt is automatically generated after the transaction. Accordingly, the customer need not enter any personal information in order to obtain an electronic receipt, such as an email address and/or a phone number.

A “quick response” code or “QR code” may be a matrix barcode and a type of machine-readable code that contains information (i.e., information pertaining to an electronic receipt). A typical QR code may use four standardized encoding modes (numeric, alphanumeric, byte/binary, and kanji) to efficiently store data. QR codes can encode financial transaction data and other transaction security data. A QR code can be used to initiate transaction activity. Two-way communication using QR codes can also improve transaction security.

In one embodiment, the paperless receipt comprises an API that produces the QR code at the POS terminal. The API can be integrated into POS systems in a wide variety of settings, such as banks, restaurants, retail shops, gas stations, grocery stores, hardware stores, etc. Further, this feature can be added directly into the current system. Any merchant could gradually reduce their costs significantly, as the need for hardware will be reduced.

In one embodiment, once the user opts for a paperless receipt, a QR code is generated that the user can scan. A QR code or the user's phone's NFC chip may be used to access the transaction receipt. Then, a mobile computing device of a user is used to scan the QR code that is associated with the user's transaction. Once scanned, the user will be taken to a secure website with their receipt. The mobile computing device displays, to the user of the mobile computing device, an interface for accessing and viewing the electronic receipt for the transaction. The receipt can then be saved and downloaded on the mobile device and placed into a folder. Specifically, the electronic receipt can then be downloaded into a shared folder on the user's mobile computing device. Others can access the shared folder at the user's discretion, such as the user's accountant and/or spouse.

In another embodiment, the QR code is associated with the user's transactions at the POS terminal. An association between the QR code and the user's transaction is generated via the API. The QR code is then provided to the user to allow the user to scan the QR code to access their transaction receipt. Once the user scans the QR code using a portable computing device, the QR code accesses the transaction receipt and the user is taken to a secure website with their receipt. Then, the user has the ability to download the transaction receipt to a shared folder.

Embodiments of the present invention may comprise or utilize special-purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general-purpose or special-purpose computer system.

Further, computer storage media (devices) include RAM, ROM, EEPROM, CD-ROM, solid state drives (“SSDs”) (i.e., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general-purpose computer, special-purpose computer, or special-purpose processing device to perform a certain function or group of functions. The computer-executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, etc.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

In one embodiment, a user completes a transaction at a POS terminal, such that the user buys something, returns something, etc. An API is then used to generate a QR code based on this transaction. Other types of scannable codes could also be used in the same manner as the QR code. The QR code is uniquely associated with the user's transaction. More specifically, the QR code can uniquely identify the transaction receipt from the transaction. In this manner, by scanning the QR code, a user is able to access their transaction receipt and download the receipt to a shared folder.

In some embodiments, the API generates the QR code at the POS terminal, such that the QR code is generated in response to the transaction. Thus, the QR code is specific to each transaction at the POS terminal and a unique QR code is generated for each transaction.

In one embodiment, each QR code represents a unique identifier. When the QR code is scanned, the unique identifier for the QR code can be determined and used to access the corresponding transaction receipt. Once obtained, the user can access and download the transaction receipt to a shared folder on their mobile computing device.

Accordingly, the present invention enables any user to perform a transaction at a POS terminal, wherein an API then generates a QR code that has been associated with the transaction receipt. The associated QR code can then be provided to the user to access their transaction receipt. The user scans the QR code and is taken to a secure website with their receipt. In this way, the QR code is generated at the time of the transaction and is visible to users to scan and access their transaction receipt.

In this manner, the user does not need to input their personal information, such as email address, phone number, etc., when downloading the transaction receipt. In some embodiments, any type of transaction applies, such as purchasing, returning, etc.

In one embodiment, an example computer environment includes a mobile computing device which may typically be a smartphone having a camera with which a QR code can be scanned. The mobile computing device is interconnected via a network with multiple server systems. The server systems can represent the systems where a user's and a POS terminal account information is stored as well as possibly other systems that are employed to generate the QR code.

The specific manner in which information is accessed and utilized to generate the QR code is not essential to the invention. The network typically will be the internet although other networks can also be employed. For example, in a typical implementation, the mobile computing device will communicate with one or more of the server systems using a Wi-Fi or cellular (i.e., 4G) connection. Also, although this specification will primarily refer to using a smartphone to scan the QR code, any mobile computing device capable of performing the described functionality could also be used (i.e., a tablet).

In one embodiment, a process of generating a QR code at a POS terminal that a user scans to access their transaction receipt is disclosed.

A user employs a transaction at a POS terminal. An API then generates a QR code to correspond with the user's transaction. Additional information, such as email addresses and phone numbers, are not needed to generate the QR code. The user then scans the QR code and accesses the transaction receipt. The transaction receipt is then downloaded into a shared folder on the user's smart device. Further, the user computing system can represent any device that a user can employ to provide information to the server system. For example, the user computing system can be a smartphone having a custom app or a web browser or a desktop, laptop, tablet, or other computer that employs a browser or other application.

The QR code can then be generated and associated with the transaction information. Once the user receives the QR code, it can be scanned. Accordingly, a user scans the QR code using a smartphone and accesses the transaction information. The scanned QR code is then used to retrieve the appropriate transaction information. Finally, the transaction information is used to access and download the transaction receipt associated with the scanned QR code.

In one embodiment, the paperless receipt can be utilized by adding the functionality to a user's bank application account, a user's bank payment card, accounting applications (i.e., Quick Books, etc.), any Cloud Storage, Apple Wallet and Google Wallet (i.e., where digital credit cards are added), loyalty incentive programs, lottery tickets, medicine instructions, assembly instructions for furniture, etc. The technology can eliminate any paper receipt, instructions, ticket, etc., and allows users to get a soft copy on their phone via scanning the generated QR code or using their phone's NFC chip to get to the URL to download their ticket, instructions, receipt, etc. Thus, linking a user's bank account and bank payment card, allows users to see their transactions from their bank account and get the receipts from their bank account and application. Further, linking receipts to their accounting applications will eliminate bookkeeping costs. Receipts from their device folder, any Cloud Storage and Apple Wallet and Google Wallet can be added directly to these digital credit card accounts. Even loyalty incentive program cards in their receipts can be added to a folder on the device to keep track of how many stamps are needed to get a free coffee, etc. If a user buys a paper lottery ticket from a gas station or other store, the paper ticket can be associated with a generated QR code. Medicine instructions can be added to the paperless receipt, as well as furniture assembly instructions. A user buying a couch or coffee table can have the assembly instructions, as well as a YouTube video that demonstrates how to assemble it, linked to your paperless receipt.

A paperless receipt provides an environmentally friendly approach to paperless transactions. The invention may be utilized at a point-of-sale transaction for a product, a point-of-sale transaction for a service, etc., through subsequent transactions associated with the original transaction, i.e., a return of a product, etc. A user is able to utilize the invention to remove the need for any paper during transactions. Thus, the invention decreases the carbon foot print by eliminating the printer and printer ribbons and ink. Generally, every single physical receipt has approximately 23 grams of CO2 emissions. Further, one ton of receipts means seventeen trees are cut down, the technology allows for the elimination of cutting trees.

Further, the invention may help benefit the environment by removing the massive amounts of paper utilized to print receipts during transactions at point-of-sale locations. The invention allows point-of-sale locations to possibly help the environment by transitioning to providing paperless electronic receipts for transactions.

Although some environmentally friendly approaches are criticized for increasing expenses for businesses to possibly help benefit the environment, the invention allows businesses to significantly reduce expenses and possibly help benefit the environment. Many businesses have large expenditures associated with the massive quantities of paper utilized to print paper receipts. Such businesses may remove those expenditures by implementing an infrastructure that interacts with the disclosed technology. Further, businesses may help encourage the utilization of the technology. In addition, businesses may even require additional fees from users that insist on paper receipts to encourage purchase and utilization of the technology.

The invention is also beneficial for consumers. Many consumers do not want to have to enter an e-mail address or provide an e-mail address to a point-of-sale representative at a point-of-sale location. Entering an e-mail address or providing the e-mail address often leads to delays. In an embodiment, the invention alleviates any need to enter a communication identifier.

Further, many consumers often have piles of receipts that are unorganized. As a result, such consumers often have difficulty finding a receipt for a possible return of a purchased product. The invention allows for users to receive receipts electronically in an organized manner. Specifically, the user places the electronic receipt in a shared folder or other suitable place. Thus, others can access the shared folder at the user's discretion, such as a spouse or accountant. The user does not have to search through piles of receipts and/or possibly lose a paper receipt. The technology electronically organizes the electronic receipts for the user. The user may obtain a refund or a product, service, etc., without the cumbersome process of searching for a paper receipt.

In one embodiment, the invention is not limited to utilization for credit card transactions. The invention may be utilized for cash transactions, credit card transactions, debit card transactions, gift card transactions, reward points transactions, and transactions that do not involve any form of payment. The invention allows a user to electronically receive and/or store receipts for any type of transaction involving a receipt. Thus, to effectively reduce and possibly eliminate the utilization of paper receipts from a store, an environmentally friendly solution has to be payment format independent.

In yet another embodiment, the paperless receipt comprises a plurality of indicia.

In yet another embodiment, a method of producing a QR code to access a paperless receipt is disclosed. The method includes the steps of providing a paperless receipt that comprises an API. The method also comprises generating a QR code at a POS terminal via the API. Further, the method comprises scanning the generated QR code via a user's phone. The method comprises once scanned, accessing their receipt via a secure website. The method also comprises downloading the digital receipt. Finally, the method comprises saving the digital receipt in a shared folder on their phone.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the paperless receipt of the present invention showing the user scanning the generated QR code in accordance with the disclosed architecture;

FIG. 2 illustrates a perspective view of one embodiment of the paperless receipt of the present invention showing how to access the paperless receipt in accordance with the disclosed architecture;

FIG. 3 illustrates a perspective view of one embodiment of the paperless receipt of the present invention showing the paperless receipt in accordance with the disclosed architecture;

FIG. 4 illustrates a perspective view of one embodiment of the paperless receipt of the present invention showing how the receipt can be downloaded in accordance with the disclosed architecture;

FIG. 5 illustrates a perspective view of one embodiment of the paperless receipt of the present invention showing the receipt saved in a folder in accordance with the disclosed architecture;

FIG. 6 illustrates a perspective view of one embodiment of the paperless receipt of the present invention showing the computer environment for the QR code in accordance with the disclosed architecture; and

FIG. 7 illustrates a flowchart showing the method of producing a QR code to access a paperless receipt in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a paperless receipt that provides an API that produces a QR code at a POS terminal that user can scan to download a digital copy of their receipt. There is also a long-felt need in the art for a paperless receipt that enables users to download their receipts from the secure website and save them in a folder on their smart device. Further, there is a long-felt need in the art for a paperless receipt that allows the user to share the folder with others, such as their spouse or accountant. Moreover, there is a long-felt need in the art for a device that eliminates the need for users to share personal information such as a phone number or email address to receive a paperless receipt. Further, there is a long-felt need in the art for a paperless receipt that provides a significant reduction of paper use and hardware which makes this invention environmentally friendly, as this solution motivates more people to use paperless systems. Finally, there is a long-felt need in the art for a paperless receipt that can be integrated into POS systems in a wide variety of settings.

The present invention, in one exemplary embodiment, is a novel paperless receipt. The invention utilizes a (API) to generate a QR code on a POS terminal for individuals opting for a paperless receipt. The paperless receipt comprises an API that produces the QR code at the POS terminal. This can be integrated into POS systems in a wide variety of settings, such as banks, restaurants, retail shops, etc. Once the user opts for a paperless receipt, a QR code is generated that the user can scan. A QR code or the user's phone's NFC chip may be used. Once scanned, the user will be taken to a secure website with their receipt. The receipt can then be saved and downloaded on the mobile device and placed into a folder. Others can access the shared folder at the user's discretion, such as the user's accountant. The present invention also includes a novel method of producing a QR code to access a paperless receipt. The method includes the steps of providing a paperless receipt that comprises an API. The method also comprises generating a QR code at a POS terminal via the API. Further, the method comprises scanning the generated QR code via a user's phone. The method comprises once scanned, accessing their receipt via a secure website. The method also comprises downloading the digital receipt. Finally, the method comprises saving the digital receipt in a shared folder.

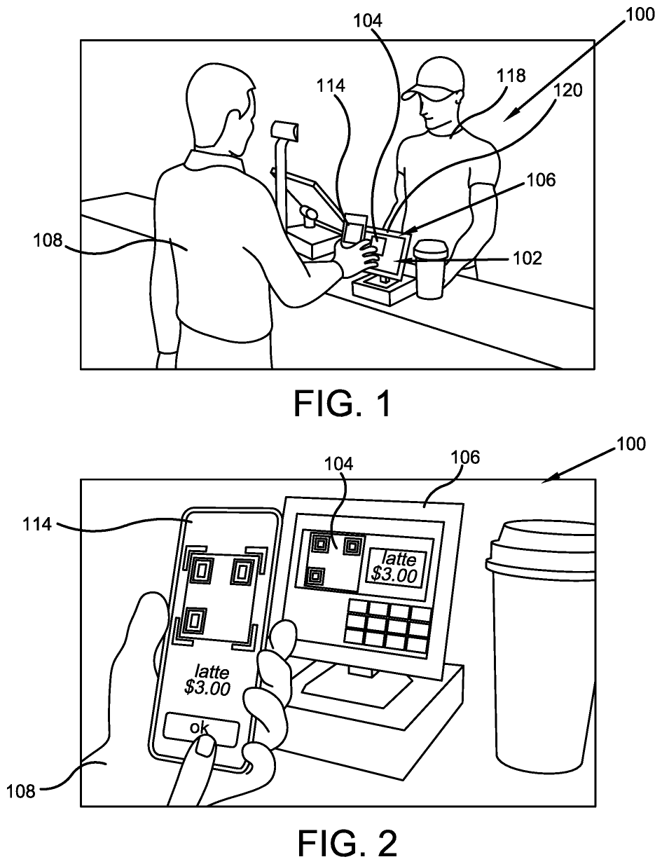

Referring initially to the drawings, FIG. 1 illustrates a perspective view of one embodiment of the paperless receipt 100 of the present invention. In the present embodiment, the paperless receipt 100 is an improved paperless receipt 100 that provides an API 102 that produces a QR code 104 at a POS terminal 106 that a user 108 can scan to download a digital copy of their receipt 110. Specifically, the paperless receipt technology 100 utilizes a POS system 106 to generate a QR code 104 for individuals 108 opting for a paperless receipt 110. The paperless receipt 100 comprises an API 102 that produces the QR code 104 at the POS terminal 106. Once the user 108 opts for a paperless receipt 110, a QR code 104 is generated on the POS terminal that the user 108 can scan. Once scanned, the user 108 will be taken to a secure website 112 with their receipt 110. The receipt 110 can then be saved and downloaded on the mobile device 114 and placed into a folder 116.

Generally, the paperless receipt 100 provides a means for generating electronic receipts 110 using data generated by a Point of Sale (POS) system 106. The POS system 106 generally includes a cash register and display, a customer PIN pad with display, and a receipt printer. Generally, most POS systems 106 are compatible with standard receipt printers. The paperless receipt technology 100 disclosed utilizes the POS system 106 to generate a QR code 104 for individuals 108 opting for a paperless receipt 110. Generally, a customer 108 makes a purchase directly with the cashier 118, using the PIN pad 120 in the customary manner to authorize payment. At some point prior to completing the transaction and having the receipt 110 printed, the customer 108 requests an electronic receipt 110. Further, in some embodiments, no customer input may be necessary and the QR code 104 associated with the electronic receipt 110 is automatically generated after the transaction. Accordingly, the customer 108 need not enter any personal information in order to obtain an electronic receipt 110, such as an email address and/or a phone number.

A “quick response” code or “QR code” 104 may be a matrix barcode and a type of machine-readable code that contains information (i.e., information pertaining to an electronic receipt). A typical QR code 104 may use four standardized encoding modes (numeric, alphanumeric, byte/binary, and kanji) to efficiently store data. QR codes 104 can encode financial transaction data and other transaction security data. A QR code 104 can be used to initiate transaction activity. Two-way communication using QR codes 104 can also improve transaction security.

Furthermore, the paperless receipt 100 comprises an API 102 that produces the QR code 104 at the POS terminal 106. The API 102 can be integrated into POS systems 106 in a wide variety of settings, such as banks, restaurants, retail shops, gas stations, grocery stores, hardware stores, etc. Further, this feature can be added directly into the current system if the POS system 106 company is the company that wants to use this feature by themselves. The company can then forgo an API 102 unless they want a third party to do this for them, the third party would control and manage the API 102. Any POS system 106 company could gradually reduce their costs significantly, as the need for hardware will be reduced.

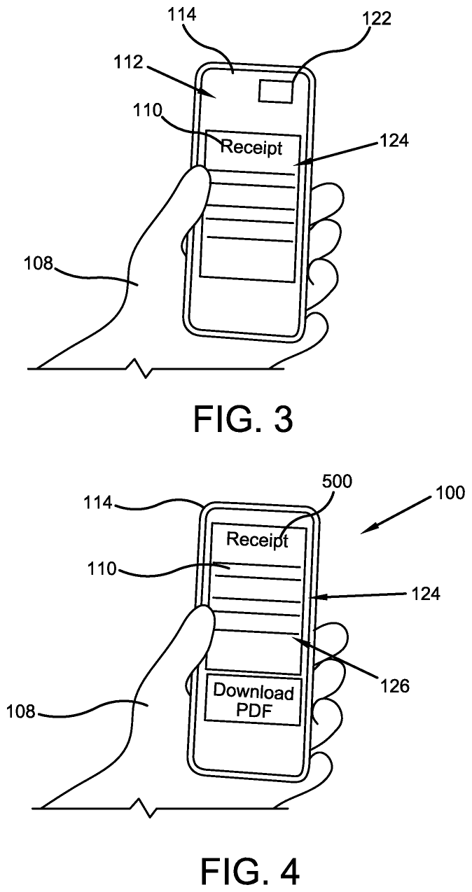

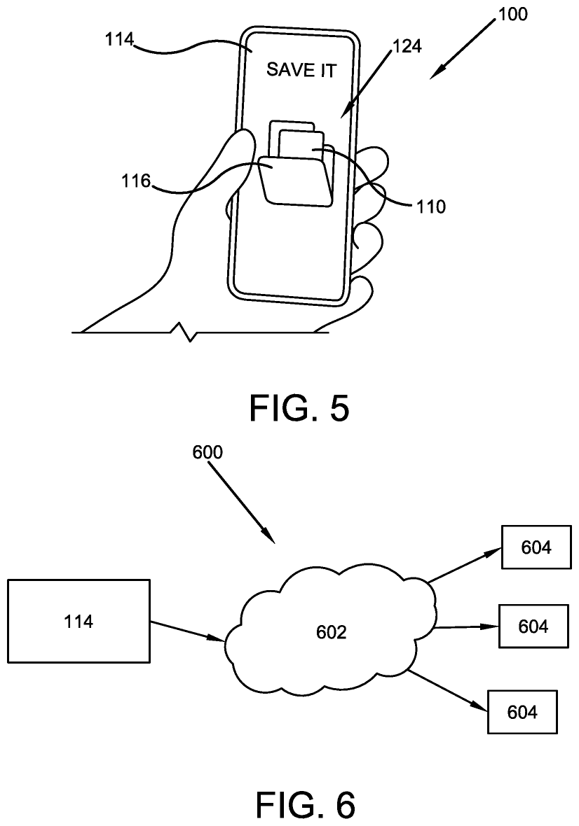

As shown in FIGS. 2-5, once the user 108 opts for a paperless receipt 110, a QR code 104 is generated that the user 108 can scan. A QR code 104 or the user's phone's NFC chip 122 may be used to access the transaction receipt 110. Then, a mobile computing device 114 of a user 108 is used to scan the QR code 104 that is associated with the user's transaction. Once scanned, the user 108 will be taken to a secure website 112 with their receipt 110. The mobile computing device 114 displays, to the user 108 of the mobile computing device 114, an interface 124 for accessing and viewing the electronic receipt 110 for the transaction. The receipt 110 can then be saved and downloaded on the mobile device 114 and placed into a folder 116. Specifically, the electronic receipt 110 can then be downloaded into a shared folder 116 on the user's mobile computing device 114. Others can access the shared folder 116 at the user's discretion, such as the user's accountant and/or spouse.

Further, the QR code 104 is associated with the user's transactions at the POS terminal 106. An association between the QR code 104 and the user's transaction is generated via the API 102. The QR code 104 is then provided to the user 108 to allow the user 108 to scan the QR code 104 to access their transaction receipt 110. Once the user 108 scans the QR code 104 using a portable computing device 114, the QR code 104 accesses the transaction receipt 110, and the user 108 is taken to a secure website 112 with their receipt 110. Then, the user 108 has the ability to download the transaction receipt 110 to a shared folder 116.

Embodiments of the present invention may comprise or utilize special-purpose or general-purpose computers including computer hardware, such as, for example, one or more processors and system memory. Embodiments within the scope of the present invention also include physical and other computer-readable media for carrying or storing computer-executable instructions and/or data structures. Such computer-readable media can be any available media that can be accessed by a general-purpose or special-purpose computer system.

Further, computer storage media (devices) include RAM, ROM, EEPROM, CD-ROM, solid state drives (“SSDs”) (i.e., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general-purpose computer, special-purpose computer, or special-purpose processing device to perform a certain function or group of functions. The computer-executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, etc.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

Generally, a user 108 completes a transaction at a POS terminal 106, such that the user 108 buys something, returns something, etc. An API 102 is then used to generate a QR code 104 based on this transaction. Other types of scannable codes could also be used in the same manner as the QR code 104. The QR code 104 is uniquely associated with the user's transaction. More specifically, the QR code 104 can uniquely identify the transaction receipt 110 from the transaction. In this manner, by scanning the QR code 104, a user 108 is able to access their transaction receipt 110 and download the receipt 110 to a shared folder 116.

Furthermore, the API 102 generates the QR code 104 at the POS terminal 106, such that the QR code 104 is generated in response to the transaction. Thus, the QR code 104 is specific to each transaction at the POS terminal 106 and a unique QR code 104 is generated for each transaction.

Typically, each QR code 104 represents a unique identifier. When the QR code 104 is scanned, the unique identifier for the QR code 104 can be determined and used to access the corresponding transaction receipt 110. Once obtained, the user 108 can access and download the transaction receipt 110 to a shared folder 116 on their mobile computing device 114.

Accordingly, the present invention enables any user 108 to perform a transaction at a POS terminal 106, wherein an API 102 then generates a QR code 104 that has been associated with the transaction receipt 110. The associated QR code 104 can then be provided to the user 108 to access their transaction receipt 110. The user 108 scans the QR code 104 and is taken to a secure website 112 with their receipt 110. In this way, the QR code 104 is generated at the time of the transaction and is visible to users 108 to scan and access their transaction receipt 110.

In this manner, the user 108 does not need to input their personal information, such as email address, phone number, etc., when downloading the transaction receipt 110. In some embodiments, any type of transaction applies, such as purchasing, returning, etc.

As shown in FIG. 6, an example computer environment 600 includes a mobile computing device 114 which may typically be a smartphone having a camera with which a QR code 104 can be scanned. The mobile computing device 114 is interconnected via a network 602 with multiple server systems 604. The server systems 604 can represent the systems where a user's and a POS terminal account information is stored as well as possibly other systems that are employed to generate the QR code 104.

The specific manner in which information is accessed and utilized to generate the QR code 104 is not essential to the invention. The network 602 typically will be the internet although other networks can also be employed. For example, in a typical implementation, the mobile computing device 114 will communicate with one or more of the server systems 604 using a Wi-Fi or cellular (i.e., 4G) connection. Also, although this specification will primarily refer to using a smartphone 114 to scan the QR code 104, any mobile computing device 114 capable of performing the described functionality could also be used (i.e., a tablet).

Furthermore, a process of generating a QR code 104 at a POS terminal 106 that a user 108 scans to access their transaction receipt 110 is disclosed. Specifically, a user 108 employs a transaction at a POS terminal 106. An API 102 then generates a QR code 104 to correspond with the user's transaction. Additional information, such as email address and phone numbers, are not needed to generate the QR code 104. The user 108 then scans the QR code 104 and accesses the transaction receipt 110. The transaction receipt 110 is then downloaded into a shared folder 116 on the user's smart device 114. Further, the user computing system can represent any device 114 that a user 108 can employ to provide information to the server system. For example, the user computing system can be a smartphone having a custom app or a web browser or a desktop, laptop, tablet, or other computer that employs a browser or other application.

The QR code 104 can then be generated and associated with the transaction information. Once the user 108 receives the QR code 104, it can be scanned. Accordingly, a user 108 scans the QR code 104 using a smartphone 114 and accesses the transaction information. The scanned QR code 104 is then used to retrieve the appropriate transaction information. Finally, the transaction information is used to access and download the transaction receipt 110 associated with the scanned QR code 104.

Further, the paperless receipt technology 100 can be utilized by adding the functionality to any of a user's accounts 126, such as a user's bank application account, a user's bank payment card, accounting applications (i.e., Quick Books, etc.), any Cloud Storage, Apple Wallet and Google wallet (i.e., where digital credit cards are added), loyalty incentive programs, lottery tickets, medicine instructions, assembly instructions for furniture, etc. The paperless receipt technology 100 can eliminate any paper receipt, instructions, ticket, etc., and allows users 108 to get a soft copy 110 on their phone 114 via scanning the generated QR code 104 or using their phone's NFC chip 122 to get to the URL 112 to download their ticket, instructions, receipt 110, etc. Thus, linking a user's bank account and bank payment card allows users 108 to see their transactions from their bank account and get to the receipts 110 from their bank account and application. Further, linking receipts 110 to their accounting applications will eliminate bookkeeping costs. Receipts 110 from any Cloud Storage and Apple Wallet or Google Wallet can be added directly to these digital credit card accounts. Even loyalty incentive program cards in their receipts 110 can be added to a folder 116 on the paperless receipt technology 100 to keep track of how many stamps are needed to get a free coffee, etc. If a user 108 buys a paper lottery ticket from a gas station or other store, the paper ticket can be associated with a generated QR code 104. Medicine instructions can be added to the paperless receipt 110, as well as furniture assembly instructions. A user 108 buying a couch or coffee table can have the assembly instructions, as well as a YouTube video that demonstrates how to assemble it, linked to their paperless receipt 110.

A paperless receipt 100 provides an environmentally friendly approach to paperless transactions. The paperless receipt technology 100 may be utilized at a point-of-sale transaction for a product, a point-of-sale transaction for a service, etc., through subsequent transactions associated with the original transaction, i.e., a return of a product, etc. A user 108 is able to utilize the paperless receipt technology 100 to remove the need for any paper during transactions. Thus, the paperless receipt technology 100 decreases the carbon foot print by eliminating the printer and printer ribbons and ink. Generally, every single physical receipt has approximately 23 grams of CO2 emissions. Further, one ton of receipts means seventeen trees are cut down, the technology 100 allows for the elimination of cutting trees.

Further, the paperless receipt technology 100 may help benefit the environment by removing the massive amounts of paper utilized to print receipts during transactions at point-of-sale locations. The paperless receipt technology 100 allows point-of-sale locations to possibly help the environment by transitioning to providing paperless electronic receipts 110 for transactions.

Although some environmentally friendly approaches are criticized for increasing expenses for businesses to possibly help benefit the environment, the paperless receipt technology 100 allows businesses to significantly reduce expenses and possibly help benefit the environment. Many businesses have large expenditures associated with the massive quantities of paper utilized to print paper receipts. Such businesses may remove those expenditures by implementing an infrastructure, if their current infrastructure is old and can't interact with the Technology (API) that interacts with the paperless receipt technology 100. Further, businesses may help encourage utilization of the paperless receipt technology 100. In addition, businesses may even require additional fees from users 108 that insist on paper receipts to encourage purchase and utilization of the paperless receipt technology 100.

The paperless receipt technology 100 is also beneficial for consumers 108. Many consumers 108 do not want to have to enter an e-mail address or provide an e-mail address to a point-of-sale representative at a point-of-sale location. Entering an e-mail address or providing the e-mail address often leads to delays. In an embodiment, the paperless receipt technology 100 alleviates any need to enter a communication identifier.

Further, many consumers 108 often have piles of receipts that are unorganized. As a result, such consumers 108 often have difficulty finding a receipt for a possible return of a purchased product. The paperless receipt technology 100 allows for users 108 to receive receipts electronically in an organized manner. Specifically, the user 108 places the electronic receipt 110 in a shared folder 116, or other suitable place. Thus, others can access the shared folder 116 at the user's discretion, such as a spouse or accountant. The user 108 does not have to search through piles of receipts and/or possibly lose a paper receipt. The paperless receipt technology 100 electronically organizes the electronic receipts 110 for the user 108. The user 108 may obtain a refund or a product, service, etc., without the cumbersome process of searching for a paper receipt.

Additionally, the paperless receipt technology 100 is not limited to utilization for credit card transactions. The paperless receipt technology 100 may be utilized for cash transactions, credit card transactions, debit card transactions, gift card transactions, reward points transactions, and transactions that do not involve any form of payment. The paperless receipt technology 100 allows a user 108 to electronically receive and/or store receipts for any type of transaction involving a receipt. Thus, to effectively reduce and possibly eliminate the utilization of paper receipts from a store, an environmentally friendly solution has to be payment format independent.

In yet another embodiment, the paperless receipt 100 comprises a plurality of indicia 500. The paperless receipt technology 100 may include advertising, a trademark, or other letters, designs, or characters, printed, painted, stamped, or integrated into the paperless receipt technology 100, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be a paperless receipt, POS terminal, or brand related.

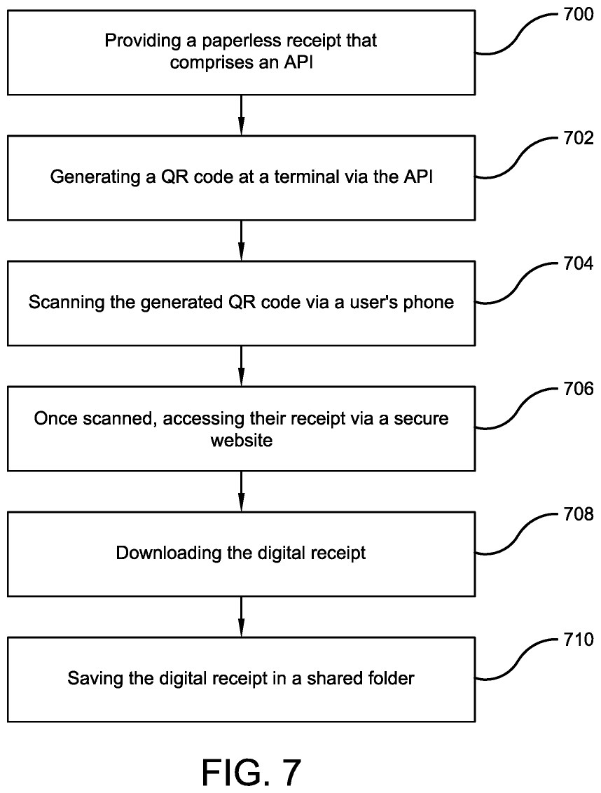

FIG. 7 illustrates a flowchart of the method of producing a QR code to access a paperless receipt. The method includes the steps of at 700, providing a paperless receipt that comprises an API. The method also comprises at 702, generating a QR code at a POS terminal via the API. Further, the method comprises at 704, scanning the generated QR code via a user's phone. The method comprises at 706, once scanned, accessing their receipt via a secure website. The method also comprises at 708, downloading the digital receipt. Finally, the method comprises at 710, saving the digital receipt in a shared folder.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “paperless receipt technology”, “technology”, and “invention” are interchangeable and refer to the paperless receipt technology 100 of the present invention.

Notwithstanding the foregoing, the paperless receipt technology 100 of the present invention can be of any suitable size and configuration as is known in the art without affecting the overall concept of the invention, provided that it accomplishes the above-stated objectives. One of ordinary skill in the art will appreciate that the paperless receipt technology 100 as shown in FIGS. 1-7 is for illustrative purposes only, and that many other sizes and shapes of the paperless receipt technology 100 are well within the scope of the present disclosure. Although the dimensions of the paperless receipt technology 100 are important design parameters for user convenience, the paperless receipt technology 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A paperless receipt that provides a user with a QR code for accessing a digital transaction receipt, the paperless receipt comprising:
an application programming interface (API);
a QR code; and
a point-of-sale (POS) terminal;
wherein a user creates a transaction at the POS terminal;
wherein the API produces a QR code associated with the transaction at the POS terminal; and
further wherein the user can access a digital receipt for the transaction by scanning the QR code.

2. The paperless receipt of claim 1, wherein the POS terminal comprises a cash register and display or a PIN pad with display, and a receipt printer.

3. The paperless receipt of claim 2, wherein the user makes a purchase directly with a cashier using the PIN pad or the cash register.

4. The paperless receipt of claim 3, wherein at some point prior to completing the transaction and having a receipt printed, the user requests the digital receipt.

5. The paperless receipt of claim 4, wherein the API can be integrated into the POS terminal at a wide variety of settings, such as banks, restaurants, retail shops, gas stations, grocery stores, or hardware stores.

6. The paperless receipt of claim 5, wherein instead of an API, the QR generation functionality can be added directly into the current system of the POS terminal.

7. The paperless receipt of claim 6, wherein instead of scanning a generated QR code, a user can utilize their phone's NFC chip to access an URL with the digital receipt.

8. The paperless receipt of claim 6, wherein a user's mobile computing device is used to scan the QR code that is associated with a user's transaction.

9. The paperless receipt of claim 8, wherein once scanned, the user will be taken to a secure website to access their digital receipt.

10. The paperless receipt of claim 9, wherein the user's mobile computing device displays an interface for accessing and viewing the digital receipt for the transaction.

11. The paperless receipt of claim 10, wherein the digital receipt can then be saved and downloaded on the user's mobile computing device.

12. The paperless receipt of claim 11, wherein the downloaded digital receipt is placed into a shared folder on the user's mobile computing device, with access at a user's discretion.

13. A paperless receipt that provides a user with a QR code for accessing a digital transaction receipt, the paperless receipt comprising:
an application programming interface (API);
a QR code; and
a point-of-sale (POS) terminal;
wherein a user creates a transaction at the POS terminal;
wherein the API produces a QR code associated with the transaction at the POS terminal;
wherein the API generates the QR code at the POS terminal, such that the QR code is generated in response to the transaction and is specific to each transaction at the POS terminal;
wherein the user can access a digital receipt for the transaction by scanning the QR code;
wherein a user's mobile computing device is used to scan the QR code that is associated with a user's transaction;
wherein instead of scanning a generated QR code, a user can utilize their phone's NFC chip to access an URL with the digital receipt;
wherein once scanned, the user will be taken to a secure website to access their digital receipt;
wherein the user's mobile computing device displays an interface for accessing and viewing the digital receipt for the transaction;
wherein the digital receipt can then be saved and downloaded on the user's mobile computing device; and
further wherein the downloaded digital receipt is placed into a shared folder on the user's mobile computing device, with access at a user's discretion.

14. The paperless receipt of claim 13, wherein the user does not need to input their personal information, such as email address or phone number when downloading the digital receipt.

15. The paperless receipt of claim 14, wherein the paperless receipt is utilized by adding functionality to any of a user's accounts, such as a user's bank application account, a user's bank payment card, accounting applications, any Cloud Storage, Apple Wallet or Google wallet, loyalty incentive programs, lottery tickets, medicine instructions, or assembly instructions for furniture.

16. The paperless receipt of claim 15, wherein the paperless receipt eliminates any paper receipt, instructions, or paper ticket, and allows users to get a soft copy on their mobile computing devices via scanning a generated QR code or using their phone's NFC chip to get to an URL to download their ticket, instructions, or digital receipt.

17. The paperless receipt of claim 16, wherein the paperless receipt provides an environmentally friendly approach to paperless transactions and removes a need for any paper and printers during transactions.

18. The paperless receipt of claim 17, wherein the paperless receipt is not limited to utilization for credit card transactions but can be utilized for cash transactions, credit card transactions, debit card transactions, gift card transactions, reward points transactions, and transactions that do not involve any form of payment.

19. The paperless receipt of claim 18 further comprising a plurality of indicia.

20. A method of producing a QR code to access a paperless receipt, the method comprising the following steps:
providing a paperless receipt that comprises an API;
generating a QR code at a POS terminal via the API;
scanning the generated QR code via a user's phone;
once scanned, accessing their receipt via a secure website;
downloading the digital receipt; and
saving the digital receipt in a shared folder.
